(19) United States
(12) Patent Application Publication
(10) Pub. No.: US 2010/0066663 A1
(43) Pub. Date: Mar. 18, 2010

(54) REMOTE CONTROL POINTING TECHNOLOGY

(75) Inventors: Galileo June Destura, Eindhoven (NL); Henk Albert Hessel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,413

(22) PCT Filed: Nov. 21, 2007
(86) PCT No.: PCT/IB07/54727

§ 371 Date: May 19, 2009

(30) Foreign Application Priority Data
Nov. 27, 2006 (EP) 06124798.7

(51) Int. Cl. G09G 5/00

(52) U.S. Cl. 345/156

(57) ABSTRACT

A system is disclosed comprising a pointing device (10), an appliance (20) and at least two light sources (30), which are either part of the appliance (20) or which are positioned in its vicinity. The pointing device (10) comprises a light detector (12) for detecting light signals from the at least two light sources (30). The system further comprises measuring means (14) for measuring a property of the detected light signals, representative of the aiming point of the pointing device (10). The system can be used for controlling a free moving cursor on the screen of the appliance (20). Alternatively, it can be used for controlling other appliances by movement or gesture of the pointing device

### BACKGROUND OF THE INVENTION

1. Technical Field

The present invention generally relates to remote control pointing technology and more particularly to a system for controlling an appliance based on the aiming point of a pointing device with respect to the appliance.

The present invention also relates to a pointing device and an appliance for use in such a system.

The present invention furthermore relates to a method for controlling an appliance based on the aiming point of a pointing device with respect to the appliance.

2. Description of Related Art

For easy interaction between a user and interactive content point-and-click operations, typically using a computer mouse, are very common and accepted. Usually, these operations are performed close to the screen and require a flat surface or a device, which is either hard to use or very expensive.

On the other hand, for lean-back and relax applications, e.g. watching video and listening to music, the remote control (RC) is commonly used. It can also be observed that the number of RC buttons is growing rapidly due to the growing complexity of the applications it controls. This has led to discontent and confusion on the part of the users on which buttons to press for a specific application.

The current problem is being compounded by the convergence of the traditional lean-back applications with the PC applications. These PC-based applications are mostly viewed through the TV screen. A dilemma arises with the convergence as both the lean back and PC world have different interaction means.

To enable ease-of-use and easy access to PC contents and applications, a pointing device is needed that can be combined with the existing remote control allowing users from the comfort of the sofa to interact with the new PC-based applications as well as old CE devices.

U.S. Pat. No. 6,975,301 B2 discloses a remote control for interactive televisions. The remote control comprises a light-scope as a remote-pointing device for defining an aiming point on the television screen. The light-scope consists of a photo detector and a lens system that defines a very narrow field of view. A LED, driven by an electric signal converted from the light signal entering the light-scope, is used to create a communicating light signal. The communicating light signal, which is to some extent a replica of the light emitted from the aiming point, is sent back to the television for determine the aiming point.

The television screen is the screen of a CRT tube or the screen of a projection display. The imaging on television screen is displayed by scanning the screen line by line with electron guns (as in the case of a CRT tube) or light guns (as in the case of a projection screen). Every full imaging is scanned in less than 1/30 second. The timing when the light from aiming point is emitted can be measured by the photo-detecting system that receives from the remote control the communicating light signal which is, to some extent, a replica of the light signal detected by photo detector in the light-scope. By comparing this measured timing with the synchronization signal for the imaging scanning, the position (or coordinates) of aiming point can be determined.

So, the system disclosed in U.S. Pat. No. 6,975,301 B2 uses the timing of the light emitted by the television to determine the aiming point of the remote control. A drawback thereof is that, for the determination of the aiming point, information on the internal functionality of the television is needed. Because of this, the determination of the aiming point is performed by the television itself. The other drawback is that the position update rate is limited and influenced by the internal functionality of the television. Furthermore, the method of U.S. Pat. No. 6,975,301 B2 would not work for some modern screens.

It is an object of the invention to provide a system using remote control pointing technology which is applicable without using information on the internal functionality of the appliance.

### SUMMARY OF THE INVENTION

These and other objects of the invention are achieved by a system according to independent claim 1, a pointing device according to independent claim 14, appliances according to independent claims 15 and 16 and a method according to independent claim 17. Favorable embodiments are defined by the dependent claims 2-13.

According to an aspect of the invention there is provided a system comprising a pointing device, an appliance and at least two light sources. The light sources are either part of the appliance or are positioned in its vicinity. The pointing device comprises a light detector for detecting light signals from the at least two light sources. The system further comprising measuring means for measuring a property of the detected light signals, representative of the aiming point of the pointing device.

In the system according to the invention no information on the internal functionality of the appliance is needed. Furthermore, it is not only usable with appliances that generate light by themselves, such as television sets, but it can be used with any type of appliance, because at least two lights sources are specifically provided for allowing the use of pointing technology.

Advantageously, the system comprises control means for controlling the appliance based on the measured property of the detected light signals. This allows the control of appliances such as a lighting dimmer, needing an analogue control or control of appliances by some gesture.

According to an advantageous embodiment the appliance comprises a screen and the control means are adapted to control the position of a cursor on the screen of the appliance based on the measured property of the detected light signals. This enables the user to interact with PC-based applications that require a free moving cursor.

In case that the appliance comprises a screen, it is advantageous that it comprises mapping means for mapping the measured signals to the screen size. In this way, the position of the aiming point of the pointing device may be determined in a very efficient way.

According to a further embodiment the measured property of the detected light signals is the amplitude thereof. The amplitude of the signal is the most reliable property of the detected light signals for measuring the aiming point of the pointing device.

Advantageously, the light sources are orthogonally modulated to make the light emitted by them mutually distinguishable. Preferably, the light sources are modulated with a unique frequency, because this is a very reliable way to make the light emitted by the different light sources distinguishable for the measuring means. However, according to the invention also other modulations may be used to make the light emitted by the light sources mutually distinguishable. Examples thereof are code multiplexing, time multiplexing and wavelength multiplexing.

According to a further preferred embodiment the pointing device comprises the measuring means and furthermore comprises transmitting means for transmitting the measured properties to the appliance. The measuring means can be easily implemented in the processor of the pointing device. The transmitting means may be constituted by an already existing LED of the pointing device, in case that the pointing device also comprises remote control circuitry. So, according to this embodiment the pointing device needs minimal technical amendments with respect to available prior art remote control devices.

Preferably, the pointing device comprises signal normalization means for normalizing the measured properties before transmitting them to the appliance. As a result thereof, the measured signals are transmitted to the appliance in a form which allows the control thereof in an efficient way without the need of much signal processing.

According to a further preferred embodiment the pointing device is adapted for transmitting a user identification to the appliance. In this way multi-user capability is added to the system.

In an alternative embodiment, the pointing device comprises reflection means for reflecting the detected light signals to the appliance and the appliance comprises the measuring means. In this way the pointing device is kept very simple and almost all the additional circuitry and processing means needed in the system are implemented, elsewhere.

According to a further preferred embodiment there is a light source on each side of the appliance. In case that the appliance comprises a rectangular screen this means that there are four light sources, allowing the determination of the aiming point in a 2 dimensional plane. However, in principle only 3 light sources are needed to determine the aiming point in a 2-dimensional plane.

Preferably, the light sources are adapted for emitting infra-red light. Since infra red-light is used in commonly available remote control technology, the use of infra-red light for implementing the pointing technology according to the present invention fits in very well with the already known technology. However, also visible light may in principle be used.

According to a further aspect of the invention a pointing device and appliances are provided for use in a system having remote control pointing technology.

According to a still further aspect of the invention a method is provided for use in a system having remote control pointing technology.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawing, in conjunction with the accompanying specification, in which:

FIG. 1 shows a block diagram of a first embodiment of the system according to the present invention.

FIG. 2 shows a diagram of the amplitude of a measured signal as a function of the frequency thereof.

FIG. 3 shows a block diagram of a second embodiment of the system according to the present invention.

Throughout the figures like reference numerals refer to like elements.

### DETAILED DESCRIPTION OF THE PRESENT INVENTION

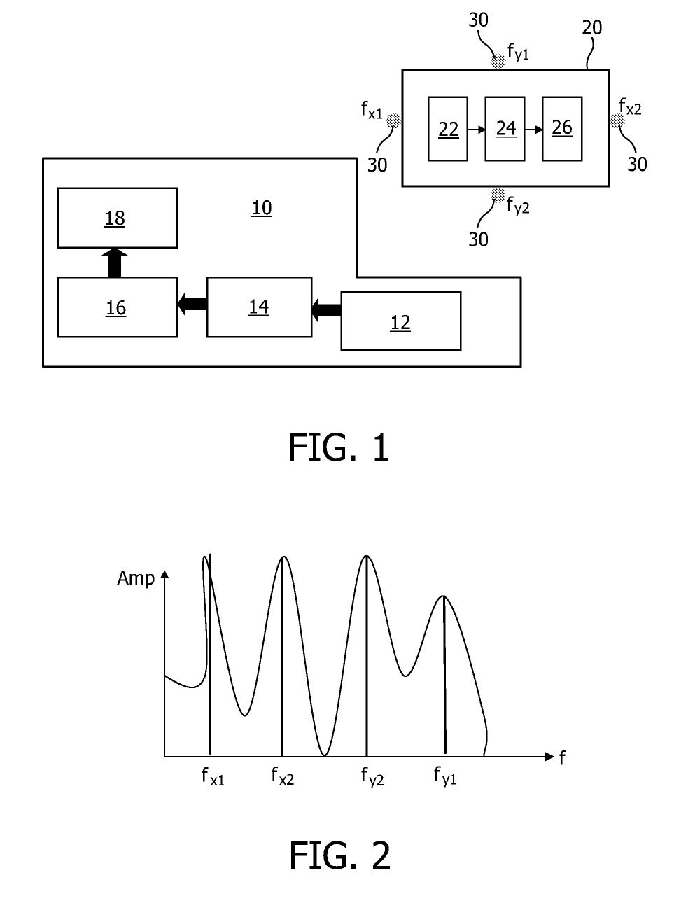

FIG. 1 shows a block diagram of a first embodiment of the system according to the present invention. The system comprises a pointing device 10 and an appliance 20. The pointing device may be part of a regular remote control comprising keys (not shown) for controlling functions of the appliance. However, preferably the pointing device is a completely novel device, which only comprises a single key or pair of keys for controlling the appliance. The appliance may be a television set on which PC-based applications can be viewed. The PC-based applications are interfaced by means of a free moving cursor. The cursor is moved on the screen by moving the pointing device.

The television set has a light source 30, preferably a light emitting diode emitting infra-red light, on each of its four sides. Each LED is modulated with a unique frequency fₓ₁, fₓ₂, f_{y1}, f_{y2}. Thus, the TV's four edges are associated with a unique frequency modulation.

Modulation by a signal having a certain frequency is a very reliable way to make the light emitted by the different light sources distinguishable for the measuring means. However, according to the invention also other modulations may be used to make the light emitted by the light sources mutually distinguishable. Examples thereof are code multiplexing, time multiplexing and wavelength multiplexing.

Instead of using light sources 30 being part of the television set, separate light sources may be used which are placed close to the edges of the television set.

The pointing device preferably is a regular remote control fitted with a light detector 12. The light detector 12 is preferably implemented as a photodiode that receives the signal from the four different LEDs 30 of the appliance 20. If the photodiode is pointed directly to the middle of the television set, the signal amplitudes received from the two LEDs arranged along the horizontal axis and the two LEDs arranged along the vertical axis are equal.

The pointing device furthermore comprises measuring means 14, preferably an amplitude detector, which can be implemented in the processor of the pointing device. In case that the pointing device is part of a regular remote control, such a processor is already available. It is used to determine the measured signal strengths of the different LEDs. An example of a measurement result is shown in FIG. 2. It shows the amplitudes of the signal at the frequencies fₓ₁, fₓ₂, f_{y1}, f_{y2}, which are used for modulating the light emitted by the four LEDs shown in FIG. 1.

The result is then normalized by normalizing means 16 and transmitted to the television set by light emitting means 18, preferably implemented as a LED emitting infra-red light. The signal is detected at the television set by a light detector 22. The normalized position on the horizontal and vertical axis is then mapped to the TV-resolution by mapping means 24, which can be implemented in the processor of the television set. So, the mapping means 24 determine the position of the aiming point of the pointing device 10. Finally, the free moving cursor is displayed at the determined position by control means 26.

Multi-user capability and user identification can be added to the system by providing means in the pointing device 10 for sending not only the normalized signal but also some form of user ID to the appliance 20, which is the television set in this case.

When the photodiode is pointed to the middle of the screen, the free moving cursor is shown in the center of the screen. When the user orients the pointing device 10 and thereby the photodiode 12 to the right while vertically staying in the middle of the screen, the amplitude of modulation frequency fₓ₂ will be higher as compared to fₓ₁ while that of two LEDs along the vertical axis will be of the same intensity. In this case, the cursor will move to the right while vertically staying the middle of the screen.

The television can be constructed in a manner that some application, which is rendered on the television, but is residing somewhere will be given the free moving cursor position.

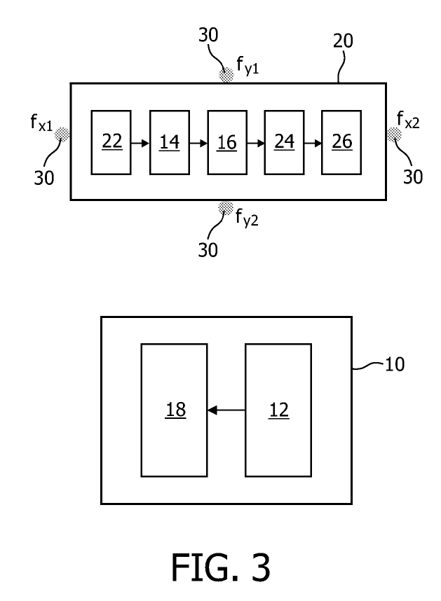

According to a second embodiment of the invention as shown in FIG. 3, the pointing device 10 is only used to reflect the detected light signal from the light sources 30 back to the appliance 20. The light detecting means 12 and light emitting means 18 together constitute reflection means. The light detecting means 12 convert the light signal in an electrical signal. The converted electrical signal, optionally after being amplified, is used to drive the LED of the light emitting means to create a light signal, which is to some extent a replica of the light signal detected by light detecting means 12. This light signal is transmitted back to the appliance 20. For a more detailed description of possible implementations of the reflecting means reference is made to the already cited patent U.S. Pat. No. 6,975,301 B2, hereby incorporated by reference, in particular to column 3, line 35 to column 4, line 45 thereof.

In the system according to the second embodiment the measuring of the light signal and the normalization thereof are performed by the appliance 20 instead of pointing device 10. Thereto, the measuring means 14 and normalization means 16 are present in the appliance 20.

The system according to the invention is not confined only to television sets but it can also be used for other devices that can show a free moving cursor on a screen. Furthermore, it can also be used to control other appliances, needing an analogue control or for appliances that can be controlled using some gesture. An example of such an appliance is lighting system comprising a fluorescent tube housing wherein the light reacts to movement of the pointing device. Moving the pointing device sideways may activate change in color and up-down may activate change in intensity (light dimming). Another example of a controllable appliance is a switch able window. A further example is sound equipment with the possibility to change the volume by moving the pointing device up or down.

In the latter examples it is not necessary to determine the aiming point of the pointing device 10. One or more parameters of the appliance are controlled based on the proportion of the amplitudes of the signals received from the light sources without first determining the aiming point of the pointing device 10.

As will be recognized by those skilled in the art, the innovative concepts described in the present application can be modified and varied over a wide range of applications. For example, although the light sources described herein are light emitting diodes emitting infra red light, any other light sources may be used, including light sources emitting visible light. Furthermore, it is noted that the present invention is not limited to appliances having four light sources such as the television set described herein above but it may be used with fewer or more light sources. Generally speaking the present invention can be used with two or more light sources. In case that there are only two light sources the aiming point of the pointing device can be determined in only one direction.

Accordingly, the scope of patented subject matter should not be limited to any of the specific exemplary teachings discussed, but is instead defined by the following claims. Any reference signs in the claims shall not be construed as limiting the scope.

1. System comprising a pointing device (10), an appliance (20) and at least two light sources (30), which are either part of the appliance (20) or which are positioned in its vicinity; the pointing device (10) comprising a light detector (12) for detecting light signals from the at least two light sources (30), the system further comprising measuring means (14) for measuring a property of the detected light signals, representative of the aiming point of the pointing device (10).

2. System according to claim 1 comprising furthermore control means (26) for controlling the appliance based on the measured property of the detected light signals.

3. System according to claim 2 wherein the appliance comprises a screen and the control means (26) are adapted to control the position of a cursor on the screen of the appliance based on the measured property of the detected light signals.

4. System according to claim 3 wherein the appliance (20) comprises mapping (24) means for mapping the measured signals to the screen size.

5. System according to claim 2 wherein the appliance (20) is a lighting system.

6. System according to claim 1, wherein the measured property of the detected light signals is the amplitude thereof.

7. System according to claim 1 wherein the light sources (30) are orthogonally modulated.

8. System according to claim 1 wherein the pointing device (10) comprises the measuring means (14) and furthermore comprises transmitting means (18) for transmitting the measured properties to the appliance (20).

9. System according to claim 8 wherein the pointing device (10) comprises signal normalization means (16) for normalizing the measured properties before transmitting them to the appliance (20).

10. System according to claim 8 wherein the pointing device (10) is adapted for transmitting a user identification to the appliance (20).

11. System according to claim 1 wherein the pointing device (10) comprises reflection means (12,18) for reflecting the detected light signals to the appliance (20) and wherein the appliance comprises the measuring means (14).

12. System according to claim 1 comprising a light source (30) on each side of the appliance (20).

13. System according to claim 1 wherein the at least two light sources (30) are adapted for emitting infra-red light.

14. Pointing device (10) for use in a system according to claim 1 comprising a light detector (12) for detecting light signals from the at least two light sources (30) and measuring means for measuring a property of the detected light signals, representative of the aiming point of the pointing device (10).

15. Appliance (20) for use in a system according to claim comprising at least two light sources (30).

16. Appliance (20) for use in a system according to claim 1 comprising control means (26) for controlling the appliance (20) based on a measured property of light signals detected by a pointing device (10), the property of the detected light signals being representative of the aiming point of the pointing device (10).

17. Method comprising the following steps:
emitting light by at least two light sources (30), which are either part of an appliance (20) or which are positioned in its vicinity;
detecting light signals from the at least two light sources (30) at a pointing device (10);
measuring a property of the detected light signals, representative of the aiming point of the pointing device (10).
